(19) United States
(12) Patent Application Publication
(10) Pub. No.: US 2023/0196761 A1
(43) Pub. Date: Jun. 22, 2023

(54) SYSTEMS AND METHODS FOR AGRICULTURAL OPERATIONS

(71) Applicant: CNH Industrial America LLC, New Holland, PA (US)

(72) Inventors: Richard Swanson, Peoria, IL (US); Andrew Berridge, Burr Ridge, IL (US); Phillip Duane Dix, Westmont, IL (US); Daniel Geiyer, Oshkosh, WI (US); Aditya Singh, Bolingbrook, IL (US); Navneet Gulati, Naperville, IL (US)

(21) Appl. No.: 17/557,207

(22) Filed: Dec. 21, 2021

(51) Int. Cl. G06V 20/10; G06T 11/00; H04N 7/18; G06T 7/73; G06V 10/44; G09G 3/00; B60K 35/00; G01C 21/00; G02B 27/01

(52) U.S. Cl. CPC G06V 20/188; G06T 11/00; H04N 7/183; G06T 7/73; G06V 10/443; G09G 3/002; B60K 35/00; G01C 21/3826; G02B 27/0101; G06T 2207/30244; G09G 2380/10; G06T 2207/30188; A01B 79/005

(57) ABSTRACT

Systems and methods for operating an agricultural system are provided herein. The method can include presenting an image of a field on a display of an electronic device. The method can also include detecting a geographic position of the electronic device and an imager direction of the imager. In addition, the method can include determining a tilt orientation of the electronic device. The method can further include determining a field of view based on the geographic position, the tilt orientation, and the imager direction. The method can also include determining one or more features of an object within the image of the field and comparing the one or more features to stored feature data. Lastly, the method can include detecting a change in the one or more features of the object.

### FIELD

The present subject matter relates generally to the acquisition and analysis of data associated with an agricultural field and to systems and methods for displaying graphics related to the data.

### BACKGROUND

Augmented reality systems supplement reality, in the form of a captured image or video stream, with additional graphics. In many cases, such systems take advantage of an electronic device's imaging and display capabilities and combine an image with graphics regarding the imaged environment that is reproduced on the display. Accordingly, a system and method that utilizes an electronic device's imaging and display capabilities while combining an image on the display with graphics regarding an imaged agricultural field would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a method for operating an agricultural system. The method includes presenting an image of a field on a display of an electronic device. The method also includes detecting a geographic position of the electronic device and an imager direction of the imager. In addition, the method includes determining a tilt orientation of the electronic device. The method further includes determining a field of view based on the geographic position, the tilt orientation, and the imager direction. The method also includes determining one or more features of an object within the image of the field and comparing the one or more features to stored feature data. Lastly, the method includes detecting a change in the one or more features of the object.

In some aspects, the present subject matter is directed to a system for an agricultural operation. The system includes an imager configured to capture one or more images. A display is configured to present the one or more images. A positioning system is configured to determine location coordinates to identify a location of the imager. An inertial measurement unit is configured to determine an imager direction of the imager and a tilt orientation of the imager, the tilt orientation being relative to one or more of a horizontal axis and a vertical axis. A computing system is communicatively coupled to the imager, the display, the positioning system, and the inertial measurement unit. The computing system includes a processor and associated memory. The memory stores instructions that, when implemented by the processor, configure the computing system to detect an object within the one or more images during a first operation, determine at least one feature of the object during the first operation; and store a location of the object and the at least one feature of the object.

In some aspects, the present subject matter is directed to a system for an agricultural operation that includes an imager configured to record an image and a display. The image includes objects and the imager having a field of view. A positioning system is configured to determine location coordinates to identify a location of the imager. An inertial measurement unit is configured to determine an imager direction of the imager and a tilt orientation of the imager. A computing system is communicatively coupled to the imager, the display, the positioning system, and the inertial measurement unit. The computing system includes a processor and associated memory. The memory stores instructions that, when implemented by the processor, configure the computing system to determine the field of view based on the location, the tilt orientation, and the imager direction, detect an object within the image, determine one or more features of the object, and store the one or features and a position of the object relative to a field map.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a schematic diagram of an agricultural machine within a field in accordance with aspects of the present subject matter;

FIG. 2 illustrates a perspective view from a cab of an agricultural machine with an electronic device therein in accordance with aspects of the present subject matter;

FIG. 3 illustrates a perspective view from the cab of an agricultural machine with the electronic device therein configured as a heads up display and a wearable device in accordance with aspects of the present subject matter;

FIG. 4 illustrates a block diagram of components of a system for receiving and illustrating graphics associated with a field in accordance with aspects of the present subject matter;

FIG. 5 is a block diagram illustrating the agricultural machine operably coupled with a remote server in accordance with aspects of the present subject matter;

FIG. 6 illustrates a schematic diagram of the agricultural machine within the field during a first operation in accordance with aspects of the present subject matter;

FIG. 7 illustrates an exemplary captured image visually augmented with a projected path of travel in accordance with aspects of the present subject matter;

FIG. 8 illustrates an exemplary captured image visually augmented with a path of travel, a prescription map, and an application map in accordance with aspects of the present subject matter;

FIG. 9 illustrates a schematic diagram of the agricultural machine within the field during a second operation in accordance with aspects of the present subject matter;

FIG. 10 illustrates an exemplary captured image visually augmented with a yield map in accordance with aspects of the present subject matter;

FIG. 11 illustrates an exemplary captured image visually augmented with a soil clod map in accordance with aspects of the present subject matter;

FIG. 12 illustrates an exemplary captured image visually augmented with a projected path of travel in accordance with aspects of the present subject matter;

FIG. 13 illustrates an exemplary captured image visually augmented with a projected path of travel and a future swath in accordance with aspects of the present subject matter;

FIG. 14 illustrates a flow diagram of a method for an agricultural operation in accordance with aspects of the present subject matter; and

FIG. 15 illustrates a flow diagram of a method for an agricultural operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to systems and methods for detecting soil clods within an agricultural field. As will be described below, a soil clod is generally characterized by a portion of soil that is denser than the surrounding soil, thereby forming a separate clod or other object that extends above a nominal height of the soil surface or other reference point or plane by a given height. Such soil clods can result in an undesirable circumstances that can impact subsequent agricultural operations within the field (e.g., a subsequent planting operation). For example, when planting seeds, it is generally not desired to have soil clods that are larger than a certain size.

In accordance with aspects of the present subject matter, the disclosed systems and methods utilize data processing algorithms to detect soil clods within regions of an agricultural field. In several embodiments, one or more field sensor(s) are used to capture data of a region of a field. The region of field may include various objects and/or a ground surface within the field. A computing system is communicatively coupled to the one or more field sensor(s). In some instances, the one or more field sensor(s) may be configured as a lidar system.

The computing system is configured to receive the captured data from the field sensor(s) of the region of the field. In several examples, the region of the field can include one or more first segments. The computing system is further configured to determine a height between the field sensor and the field for each of the one or more segments within the first region of the field. The computing system may further be configured to generate a terrain plot indicative of a distance between the field sensor and each of the one or more segments within the region of the field.

The computing system may also be configured to generate a first reference line based on the first terrain plot. A first segment has a negative height relative to the reference line and a second segment has a positive height relative to the reference line. As such, the reference line may be generally linear and/or offset from a ground surface of the field (or one or more segments). The computing system may identify the one or more first segments of the first terrain plot as a soil clod based on the second height exceeding a defined threshold. By using a reference line that is offset from the ground surface, movement of the implement may have a smaller effect on errors caused by movement of the implement as the agricultural machine traverses the field. In addition, the field sensor(s) may utilize various data acquisition techniques that allow for the detection of terrain during low visibility conditions, which may include dusty conditions, low light conditions, and/or any other condition.

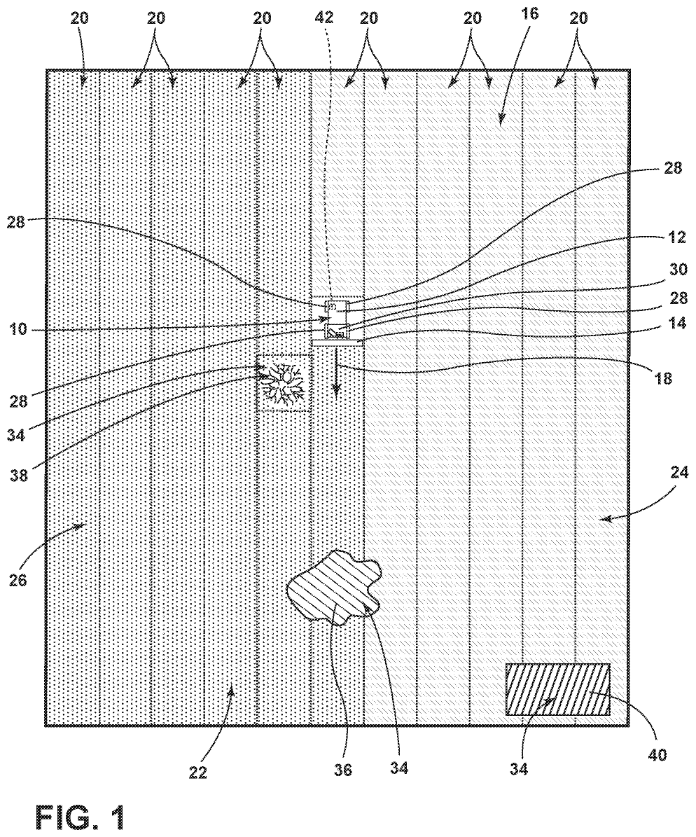

Referring now to drawings, FIG. 1 is a schematic diagram of an embodiment of an agricultural machine 10, which may include a work vehicle 12 and an agricultural implement 14 within an agricultural field 16. In the illustrated embodiment, the work vehicle 12 is depicted as an agricultural harvester that is configured to perform a harvesting operation. In other embodiments, the work vehicle 12 may perform any other operation, such as a tilling operation, an application operation, a seeding or planting operation, among others. Additionally or alternatively, the work vehicle 12 may be a construction vehicle, a mining vehicle, a passenger vehicle, or the like. The work vehicle 12 or other prime mover is configured to move the agricultural implement 14 throughout the field 16 along a direction of travel 18. In various embodiments, the work vehicle 12 is steered (e.g., via an operator or an automated system) to traverse the field 16 along substantially parallel rows or swaths 20. However, the work vehicle 12 may be steered to traverse the field 16 along other routes, such as along spiral paths, curved paths, obstacle avoidance paths, and so on. While the agricultural implement 14 is positioned in front of the work vehicle 12 in the illustrated embodiment, it should be appreciated that in alternative embodiments, the agricultural implement 14 may be integrated within the work vehicle 12, behind the work vehicle 12, and/or otherwise coupled with the work vehicle 12.

In general, when the agricultural vehicle 10 is configured as a harvester, the harvester is configured to sever crops material 22 from the field 16 and direct the crop material 22 into the harvester. As such, as the field 16 is processed by the harvester, and/or any other agricultural machine 10, the field 16 may have a processed segment 24 and an unprocessed segment 26. Within the harvester, the crop material 22 may be separated into harvest material (e.g., grain) and non-harvest material (e.g., material other than grain (MOG), straw, previously harvested crop, etc.). The harvest material may be stored within the harvester and/or directed into a storage space, such as a storage cart. The non-harvested crop may be exhausted from the harvester back into the field 16.

As illustrated, the harvester includes a chassis, ground engaging wheels 28, an operator cab 30, and a harvesting system 32. The wheels 28 may be configured to support the harvester relative to the field 16 (or another ground surface) and move the agricultural harvester in a direction of forward travel 18 across the field 16. The cab 30, or any other form of operator's station, may house various control or input devices (e.g., levers, pedals, control panels, buttons, and/or the like) for permitting an operator to control the operation of the harvester.

As the work vehicle 12 and the agricultural implement 14 traverse the field 16, the work vehicle 12 and the agricultural implement 14 may encounter various field conditions and soil conditions, as well as certain structures. Such field conditions, soil conditions, and/or structures may be defined as objects 34 for purposes of the description herein. For example, the work vehicle 12 and the agricultural implement 14 may encounter objects 34 such as a pond 36, one or more trees 38, a building or other standing structure 40, miscellaneous features, and so on. The miscellaneous features may include water pumps, above ground fixed or movable equipment (e.g. irrigation equipment, planting equipment), and so on.

In addition, as the work vehicle 12 traverses the field 16, one or more operation sensors 42 may capture data that is indicative of various operating conditions. For example, the operation sensor 42 may be configured to capture data related to at least one of the work vehicle 12, the implement 14, the field 16, the crop material 22 within the field 16, and/or any other condition that can affect the operation. In various instances, the data may relate to a yield of the harvested crop, an application pattern or volume of agricultural product to be applied, a future path for the vehicle 12, an already traversed path of the machine 10, a number or size of clods in the field 16, a number or size of any other object 34 in the field 16, one or more operational parameters of the vehicle 12 (or a component thereof), one or more operational parameters of the implement 14 (or a component thereof), one or more field conditions, one or more other crop conditions one or more environmental conditions, and/or any other data that may be related to the vehicle 12, the implement 14, the field 16, and/or any operation that may be performed within the field 16 and/or with the vehicle 12.

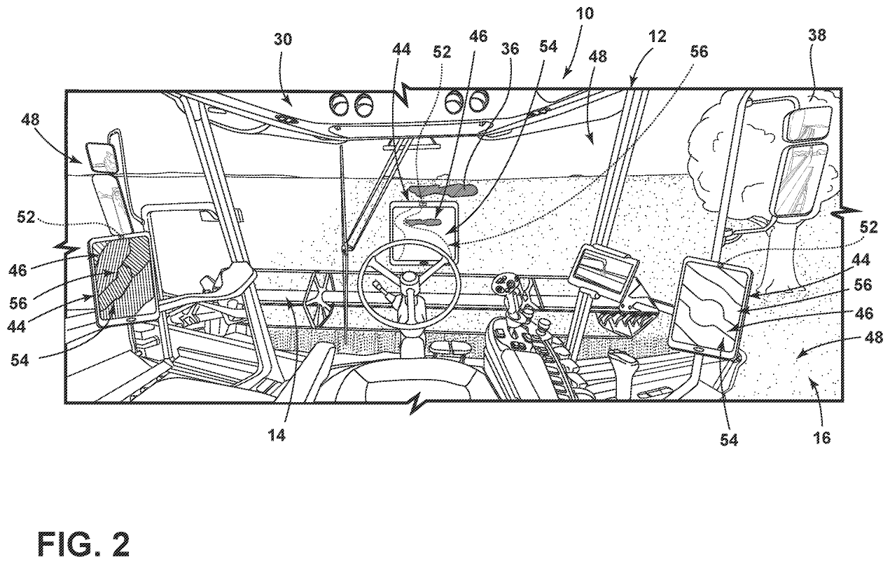

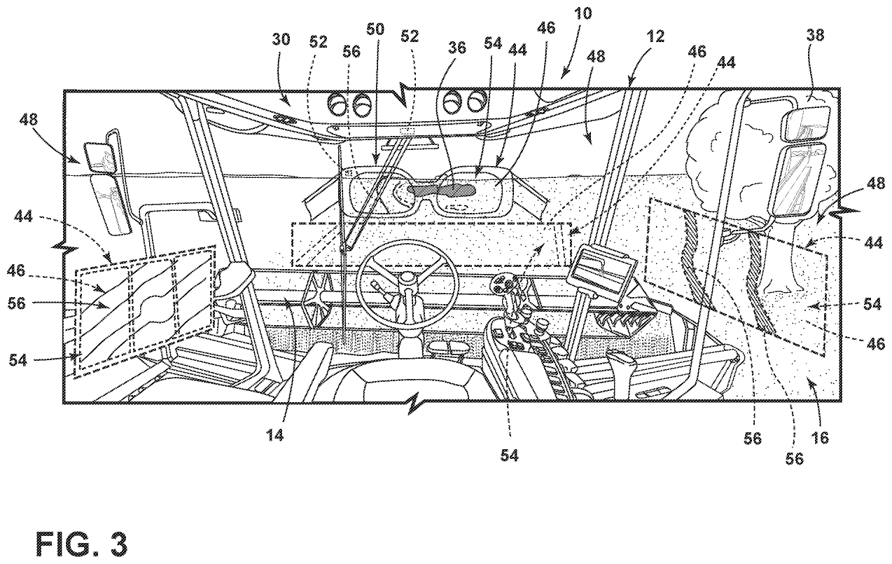

Referring to FIGS. 2 and 3, an electronic device 44 having a display 46 may be used in conjunction with the agricultural machine 10. In various examples, the electronic device 44 may be in the form of a tablet, cellular phone, or the like, as shown in FIG. 2. Additionally or alternatively, the electronic device 44 may be a heads-up display (HUD) that is integrated into one or more windows 48 of the cab 30, and/or any other device 44 that may be integrated within a cab 30 of the work vehicle 12. Additionally or alternatively, the electronic device 44 may be in the form of a wearable device 50, such as glasses. However, the electronic device 44 may be any other device having the capability to display an image without departing from the teachings provided herein.

In various examples, the electronic device 44 may include an imager 52, which may provide an image 54, a set of images 54, and/or a video stream, of a surrounding environment. The surrounding environment may be based on a field of view of the imager 52 and the direction in which the field of view is aimed and/or the tilt of the imager 52 and/or electronic device 44. In addition, in some instances, the electronic device 44 may augment the displayed images 54 with additional graphics 56. In such instances, the electronic device 44 displays various types of graphics 56 based on the data provided by the operation sensors 42.

As shown in FIGS. 2 and 3, the electronic device 44 can augment the captured image 54 with a yield map illustrating variations in harvest yields of a harvested portion of the field 16, swath guidelines of a to be harvested portion of the field 16, and/or objects 34 within the field 16. This allows the user to receive additional graphics 56 while performing an operation within the field 16.

In operation, the electronic device 44 can detect a geographic position, an imager direction, and a tilt of the electronic device 44. The geographic position of the electronic device 44 can be determined using location coordinates or using triangulation methods using cell phone towers. In yet another example, a blend of location coordinates and triangulation information can be used to determine the position of the electronic device 44. The imager direction can be a direction relative to a planet's magnetic field (i.e., Earth's magnetic field) in which the imager 52 is pointing. The imager direction can be considered a direction that can be identified using a compass, such as a digital compass. The imager direction can be used to identify the direction in which the imager 52 is pointing as it acquires an image 54 to be augmented using the present technology. The tilt direction is a direction that determines the direction in which either the imager 52 or display 46 is pointing relative to a horizontal or vertical axis.

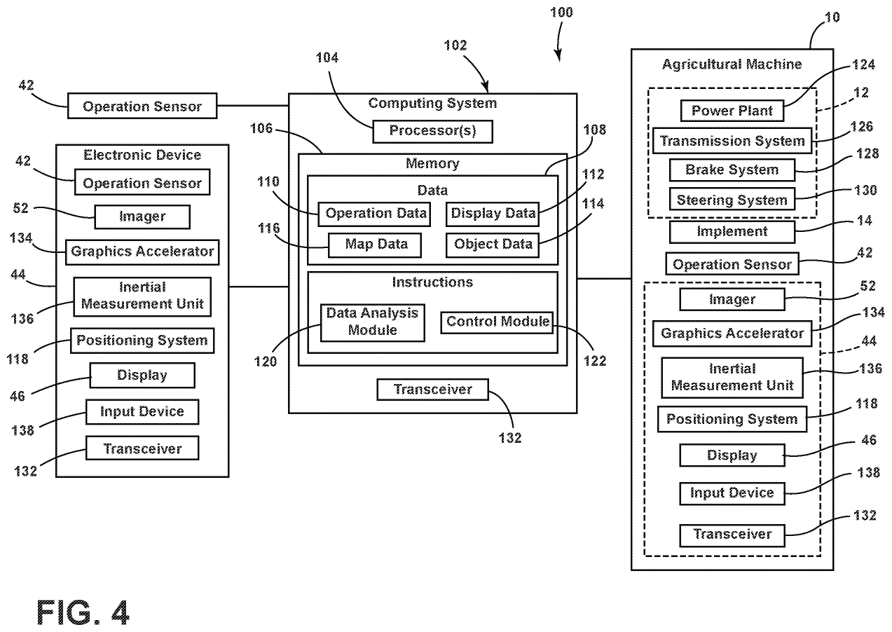

Referring now to FIG. 4, a schematic view of a system 100 for receiving and illustrating graphics 56 associated with a field 16 and/or an agricultural operation is illustrated in accordance with aspects of the present subject matter. The system 100 will generally be described herein with reference to the agricultural machine 10 described above with reference to FIGS. 1-3. However, the disclosed system 100 may generally be utilized with agricultural machines having any other suitable machine configuration.

As shown in FIG. 4, the system 100 may include one or more operation sensors 42 configured to capture data that is indicative of various operations. The system 100 may further include a computing system 102 communicatively coupled to the one or more operation sensors 42. In several embodiments, the computing system 102 may be configured to receive and process the data captured by the one or more operation sensors 42 to allow graphics 56 related to the agricultural machine 10, the field 16, the crop material 22, and/or the operation to be determined. For instance, the computing system 102 may be configured to execute one or more suitable data processing algorithms for determining any graphics 56 of interest.

In general, the computing system 102 may include any a suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 106 of the computing system 102 may generally comprise memory element(s) including, but not limited to, a computer-readable medium (e.g., random access memory (RAM)), a computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store suitable computer-readable instructions that, when implemented by the processor 104, configure the computing system 102 to perform various computer-implemented functions, such as one or more aspects of the data processing algorithms and/or related methods described below. In addition, the computing system 102 may also include various other suitable components, such as a communications circuit or module, one or more input/output channels, a data/control bus, and/or the like.

In several embodiments, the computing system 102 may correspond to an existing controller of the agricultural machine 10, or the computing system 102 may correspond to a separate processing device. For instance, in some embodiments, the computing system 102 may form all or part of a separate plug-in module or computing device that is installed relative to the work vehicle 12 or implement 14 to allow for the disclosed system 100 and method to be implemented without requiring additional software to be uploaded onto existing control devices of the work vehicle 12 or implement 14. Additionally or alternatively, the computing system 102 may be remote and/or separated from the vehicle 12 and/or the machine 10.

In various embodiments, the memory 106 of the computing system 102 may include one or more databases 108 for storing information received and/or generated by the computing system 102. For instance, as shown in FIG. 4, the memory 106 may include an operation database 110 storing data associated with the operation data captured by the one or more operation sensors 42, including the captured data and/or data deriving from the captured data. Additionally, the memory 106 may include a display database 112 storing data associated with a geographic position, an imager direction, and a tilt of the electronic device 44 and/or any information generated by the computing system 102 to be displayed on the electronic device 44. For instance, as indicated above, the electronic device 44 may capture an environment proximate thereto through the imager 52. In addition, the computing system 102 may generate graphics 56 that may be overlaid on the image 54 to provide the graphics 56 to the user.

Additionally or alternatively, as shown in FIG. 4, the memory 106 may also include an object database 114, which may be configured to store object data related to one or more objects 34 that are within the field 16. In various examples, the object data may be received from the imager 52 and/or the operation sensors 42. In addition, one or more features (e.g., shape, size, location, etc.) of the object 34 may be stored for any operation that is performed within the field 16. In addition, the object data may be inputted through a third party, an operation sensor 42, human input, and/or any other method.

Additionally or alternatively, as shown in FIG. 4, the memory 106 may also include a map database 116, which may be configured to store map data generated by a positioning system 118 that is stored in association with the operation data and/or the object data. The positioning system 118 may be configured to determine location coordinates identifying the location of the imager 52 and/or later used in geo-locating the operation data and/or the object data relative to the field 16. In some embodiments, the positioning system 118 may be configured as a satellite navigation positioning device (e.g. a GPS, a Galileo positioning system, a Global Navigation satellite system (GLONASS), a BeiDou Satellite Navigation and Positioning system, a dead reckoning device, and/or the like) to determine the location of the machine 10.

The map database 116 may further include data that can be obtained from any topology mappings of the field 16. Any mapping service and/or device may be used to obtain a map of the field 16, which may be stored within the map database 116. Additionally or alternatively, the topology of the farm can be fed into the system 100 from open-source data and/or other third-party data.

Moreover, as shown in FIG. 4, in several embodiments, the instructions stored within the memory 106 of the computing system 102 may be executed by the processor 104 to implement a data analysis module 120. In general, the data analysis module 120 may be configured to process/analyze the captured data received from the one or more operation sensors 42, the data received from the imager 52, and/or the data deriving therefrom to estimate or determine graphics 56 related to the vehicle 12, the field 16, the crop material 22, and/or the operation. In several embodiments, the data analysis module 120 may be configured to execute one or more data processing algorithms to allow a yield of the crop material 22 to be identified by the computing system 102. Additionally or alternatively, the data analysis module 120 may be configured to execute one or more data processing algorithms to allow a suggested prescription of an agricultural product to be identified by the computing system 102. Further, the data analysis module 120 may be configured to execute one or more data processing algorithms to allow an application of an agricultural product to be identified by the computing system 102. Additionally or alternatively, the data analysis module 120 may be configured to execute one or more data processing algorithms to allow a suggested path of the work vehicle 12 to be identified by the computing system 102. Additionally or alternatively, the data analysis module 120 may be configured to execute one or more data processing algorithms to allow a suggested path of the work vehicle 12 to be identified by the computing system 102. Additionally or alternatively, the data analysis module 120 may be configured to execute one or more data processing algorithms to allow a field topography to be identified by the computing system 102. Additionally or alternatively, the data analysis module 120 may be configured to execute one or more data processing algorithms to allow an object map to be identified by the computing system 102.

Still further, in some examples, the data analysis module 120 may be configured to compare any of the raw data and/or processed data to historical data. For example, in some instances, the computing system 102 may use one or more image processing algorithms to compare the object data from a first operation to the object data from a subsequent operation to identify any changes. The changes may be identified by the computing system 102 and provided to the memory 106 of the computing system 102 and/or to the user as graphics 56 of interest.

Referring still to FIG. 4, in some embodiments, the instructions stored within the memory 106 of the computing system 102 may also be executed by the processor 104 to implement a control module 122. In general, the control module 122 may be configured to electronically control the operation of one or more components of the system 100. For instance, in several embodiments, the control module 122 may be configured to control the graphics 56 to be displayed on the display 46.

In addition, in various embodiments, the control module 122 may control the operation of one or more components of the work vehicle 12, such as a power plant 124, a transmission system 126, a brake system 128, and/or a steering system 130 of the vehicle 12 to automatically adjust the agricultural machine 10 based on the generated graphics 56. In addition (or as an alternative thereto), the control module 122 may be configured to electronically control the operation of one or more components of the implement 14. For instance, the control module 122 may be configured to adjust the operating parameters associated with one or more of the ground-engaging tools of the implement 14 (e.g., disc blades, shanks, leveling blades, and/or basket assemblies) to proactively or reactively adjust the operation of the implement 14 in view of the generated graphics 56.

In several embodiments, the computing system 102 and/or the electronic device 44 may include a transceiver 132 to allow for the computing system 102 and/or the electronic device 44 to communicate with various components. For instance, one or more communicative links or interfaces (e.g., one or more data buses) may be provided between the transceiver 132 of the computing system 102 and the transceiver 132 of the electronic device 44. As provided herein, electronic device 44 may be any device that includes a display 46 for displaying graphics 56 to a user, which may be a standalone device and/or a device that is integrated within the agricultural machine 10. In instances in which the electronic device 44 is integrated into the agricultural machine 10, one or more components of the electronic device 44 may be used for multiple uses.

The electronic device 44 may present graphics 56 to the user and may be capable of receiving remote user inputs. In addition, the electronic device 44 may provide feedback graphics 56, such as visual, audible, and tactile alerts, and/or allow the operator to alter or adjust one or more components of the agricultural machine 10 through the usage of the remote electronic device 44. The electronic device 44 may include the computing system 102 therein and/or include a variety of unique computing systems that include a processor and memory.

As illustrated, the electronic device 44 may include the imager 52, a graphics accelerator 134, an inertial measurement unit (IMU) 136, the positioning system 118, the display 46, an input device, and/or a transceiver 132.

In several examples, the imager 52 may correspond to any suitable camera, such as a single-spectrum camera or a multi-spectrum camera configured to capture image data, for example, in the visible light range and/or infrared spectral range. Additionally, in various embodiments, the imager 52 may correspond to a single lens camera configured to capture two-dimensional image data or a stereo camera having two or more lenses with a separate image imaging device for each lens to allow the cameras to capture stereographic or three-dimensional image data. Alternatively, the imager 52 may correspond to any other suitable image capture devices and/or other imaging devices capable of capturing “image data” or other image-like data of the field 16. In various examples, a plurality of images captured may be captured sequentially by the imager 52 to form a video stream. In such cases, the graphics 56 is overlaid over each of the plurality of images of the video stream.

In general, the graphics accelerator 134 can be a specialized graphics rendering subsystem that generates three-dimensional geometry input data to define three-dimensional graphics elements for display on the display 46. The graphics accelerator 134 can transfer the geometry input data to the graphics accelerator 134. Thereafter, the graphics accelerator 134 renders the corresponding graphics elements on the display 46.

In some examples, the IMU 136 can be configured to determine an imager direction of the imager 52 and a tilt orientation of the imager 52 with the tilt orientation being relative to one or more of a horizontal axis and a vertical axis using a combination of accelerometers, gyroscopes, magnetometers, and/or any other practicable device. The accelerometer may correspond to one or more multi-axis accelerometers (e.g., one or more two-axis or three-axis accelerometers) such that the accelerometer may be configured to monitor the movement of the electronic device 44 and/or the display 46 in multiple directions, such as by sensing the acceleration along three different axes. It will be appreciated, however, that the accelerometer may generally correspond to any suitable type of accelerometer without departing from the teachings provided herein. In some examples, the IMU 136 may include more than one device. For example, the IMU 136 can include a digital compass configured to determine the imager direction of the imager 52 and an accelerometer for determining a tilt orientation of the imager 52.

In various examples, the display 46 may be configured as any practicable type of electronic device 44 or part of a device that presents graphics 56 in visual form. For instance, in some examples, the display 46 may be configured as a heads-up display (HUD). The HUD may display a heads-up image on a window 48, or any other surface, of the cab 30. The HUD allows a transparent or semi-transparent display to present data without the user looking away from their typical viewpoints. In the agricultural machine scenario, it allows a driver to view graphics 56 while being able to maintain focus on the field 16, rather than traditional display areas, such as the instrument cluster or center stack. The HUD may contain a projector unit, a combiner, and a display generation device. The HUD may include a convex lens or a concave mirror with an LED/LCD at its focus.

Additionally or alternatively, the display 46 may be configured as a light-emitting diode display (LED), an electroluminescent display (ELD), an electronic paper, E Ink, a plasma display panel (PDP), a liquid crystal display (LCD), a high-performance addressing display (HPA), a thin-film-transistor display (TFT), an organic light-emitting diode display (OLED), a Digital Light Processing display (DLP), a surface-conduction electron-emitter display (SED), a field emission display (FED), a laser display, carbon nanotubes, a quantum dot display (QLED), an interferometric modulator display (IMOD), a digital micro shutter display (DMS), a microLED, three-dimensional display, a holographic display, and/or any other type of display.

In some examples, the display 46 may include the user input device 138 in the form of circuitry to receive an input corresponding with a location over the display 46. Additionally or alternatively, the electronic device 44 may further include one or more other input devices 138, such as keypads, touchpads, knobs, buttons, sliders, switches, mice, microphones, and/or the like, which are configured to receive user inputs from the user.

In operation, the one or more operation sensors 42 allow graphics 56 related to the vehicle 12, the field 16, the crop material 22, and/or the operation to be provided to the computing system 102. The one or more operation sensors 42 may be standalone sensors, integrated within the agricultural machine 10, and/or integrated within the electronic device 44.

In addition, instructions can be received through an input device 138 that instructs the system 100 to execute functions in an augmented reality application. One potential instruction can be to generate an augmented reality map illustrating graphics 56 related to one or more agricultural applications. In that case, the imager 52 may begin feeding one or more images 54 to the display 46. In some embodiments, images 54 recorded by the imager 52 can be first sent to the graphics accelerator 134 for processing before the images 54 are displayed.

The system 100 can also receive location and orientation information from devices such as a positioning system 118, a transceiver 132, an IMU 136, and/or any other device. The positioning system 118 can determine location coordinates and can communicate them to the computing system 102. Likewise, the computing system 102 can determine the location of the electronic device 44 through triangulation techniques using signals received by the transceiver 132. The computing system 102 can determine the orientation of the electronic device 44 by receiving directional information and tilt information from the IMU 136.

The computing system 102 can also receive map data corresponding to the area surrounding the geographical location of the electronic device 44. In some embodiments, the computing system 102 can receive signals from the input device 138, which can be interpreted by the computing system 102 to be a search request for map data including graphics 56 of interest.

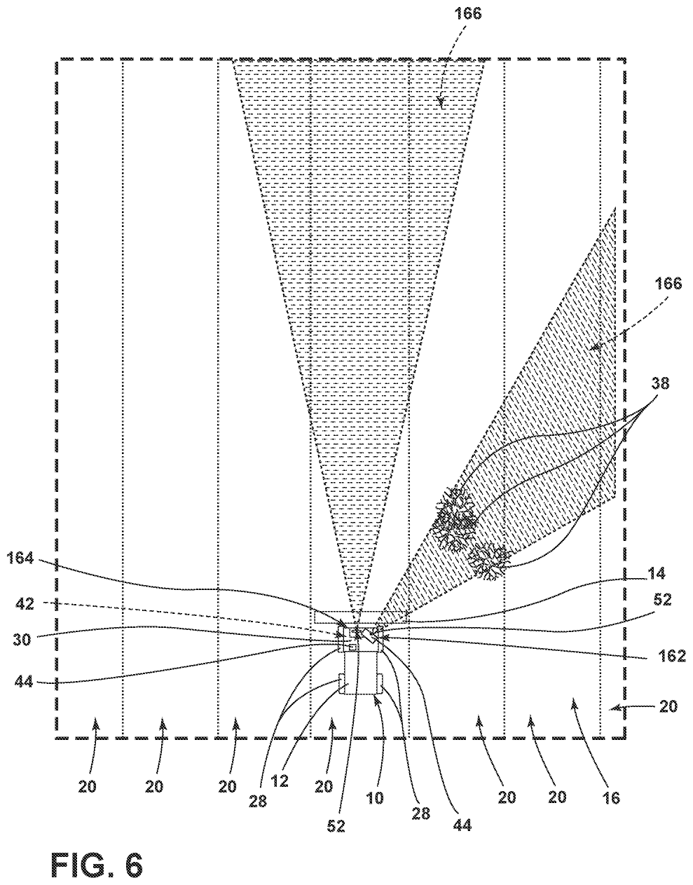

The computing system 102 can interpret the location and orientation data received from the IMU 136 and/or the positioning system 118 to determine the direction in which the imager 52 is facing. Using this information, the computing system 102 can further correlate the location and orientation data with the map data, the operation data, the object data, and the images 54 to identify an environment recorded by the imager 52 and displayed on the display 46 to determine a field of view 166 (FIG. 6) and to match an object 34 within the field of view 166 with the object 34 as represented in the map data. In various examples, the object 34 may be a crop material 22, a weed, a field surface, a tree 38, a building, and/or any other detectable object 34. The computing system 102 can receive other inputs via the input device 138 such as an input that can be interpreted as a selection for a type of graphics 56 to be displayed on the display 46. The computing system 102 can further interpret the map data to generate and display the graphics 56 on the displayed image 54 for providing the graphics 56 to the user.

In some examples, the system 100 may further be configured to detect an object 34 within the one or more images 54 during a first operation, determine at least one feature of the object 34 during the first operation, and store a location of the object 34 and the at least one feature of the object 34. The system 100 may further be configured to detect the object 34 within the one or more images 54 during a second operation, determine the at least one feature of the object 34 during the second operation, and detect one or more changes to the at least one feature based on the one or more images 54 during the first operation and the one or more images 54 during the second operation. In some instances, the system 100 may further be configured to update a field map based on the one or more changes to the at least one feature.

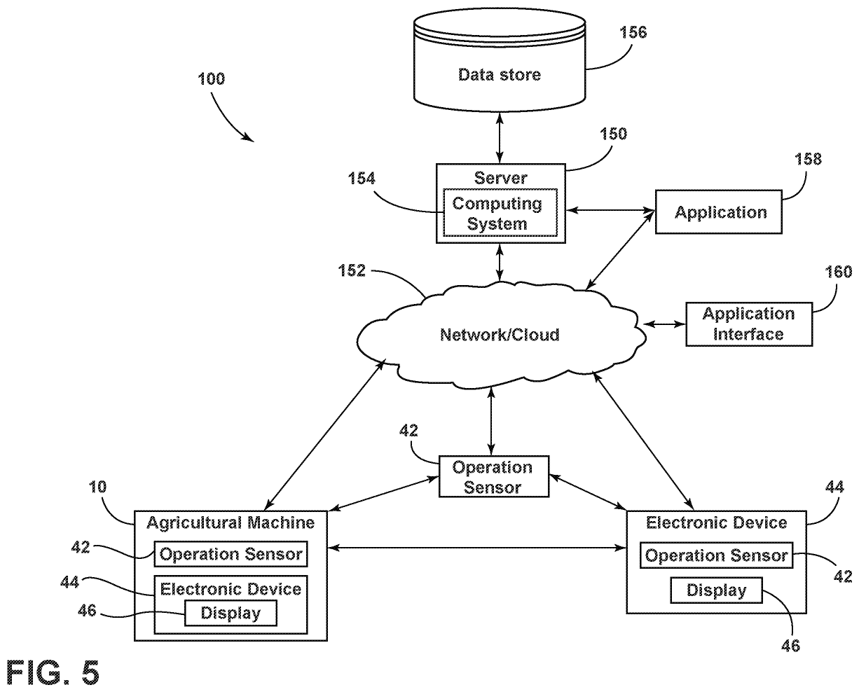

As provided herein, the computing system 102 may be implemented within the electronic device 44, the agricultural machine 10, and/or within a device that is remote from both the electronic device 44 and the agricultural machine 10. In addition, it will be appreciated that, although the various control functions and/or actions will generally be described herein as being executed by the computing system 102, one or more of such control functions/actions (or portions thereof) may be executed by a separate computing system or may be distributed across two or more computing systems (including, for example, the computing system 102 and a separate computing system). For instance, in some embodiments, the computing system 102 may be configured to acquire data from the one or more operation sensors 42 for subsequent processing and/or analysis by a separate computing system (e.g., a computing system 154 (FIG. 5) associated with a remote server 150). In other embodiments, the computing system 102 may be configured to execute the data analysis module 120 to determine and/or monitor data from the one or more operation sensors 42 while a separate computing system may be configured to execute the control module 122 to control the operation of the electronic device 44 and the display 46 therein.

Referring to FIG. 5, in some examples, the agricultural machine 10 and/or the electronic device 44 may be communicatively coupled with one another and/or one or more remote sites, such as a remote server 150 via a network/cloud 152 to provide data and/or other information therebetween. The network/cloud 152 represents one or more systems by which the agricultural machine 10 and/or the electronic device 44 may communicate with the remote server 150. The network/cloud 152 may be one or more of various wired or wireless communication mechanisms, including any desired combination of wired and/or wireless communication mechanisms and any desired network topology (or topologies when multiple communication mechanisms are utilized). Exemplary communication networks 152 include wireless communication networks (e.g., using Bluetooth, IEEE 802.11, etc.), local area networks (LAN) and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 152 in FIG. 5). The verbal image has been formalized in the newer concept of cloud computing. The National Institute of Standards and Technology (NIST) defines cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not the same, these terms are generally used interchangeably herein, and they may be referred to collectively as the network/cloud 152.

The server 150 may be one or more computer servers, each of which may include a computing system 154 including at least one processor and at least one memory, the memory storing instructions executable by the processor, including instructions for carrying out various steps and processes. The server 150 may include or be communicatively coupled to a data store 156 for storing collected data as well as instructions and/or data for the agricultural machine 10 and/or the electronic device 44 with or without intervention from a user, the agricultural machine 10, and/or the electronic device 44. Moreover, the server 150 may be capable of analyzing initial or raw sensor data received from the one or more operation sensors 42, and final or post-processing data (as well as any intermediate data created during data processing). Accordingly, the instructions and/or data provided to the agricultural machine 10 and/or the electronic device 44 may be determined and generated by the server 150 and/or one or more cloud-based applications 272. In such instances, the electronic device 44, whether integrated within the agricultural machine 10 and/or remote from the agricultural machine 10, may be a dummy device that provides various instructions and/or data based on instructions from the network/cloud 152.

With further reference to FIG. 5, the server 150 also generally implements features that may enable the agricultural machine 10 and/or the electronic device 44 to communicate with cloud-based applications 272. Communications from the electronic device 44 can be directed through the network/cloud 152 to the server 150 and/or cloud-based applications 272 with or without a networking device, such as a router and/or modem. Additionally, communications from the cloud-based applications 272, even though these communications may indicate one the agricultural machine 10 and/or the electronic device 44 as an intended recipient, can also be directed to the server 150. The cloud-based applications 272 are generally any appropriate services or applications 272 that are accessible through any part of the network/cloud 152 and may be capable of interacting with the electronic device 44.

In various examples, the electronic device 44, whether integrated within the agricultural machine 10 and/or remote from the agricultural machine 10, can be feature-rich with respect to communication capabilities, i.e. have built-in capabilities to access the network/cloud 152 and any of the cloud-based applications 272 or can be loaded with, or programmed to have such capabilities. The agricultural machine 10 and/or the electronic device 44 can also access any part of the network/cloud 152 through industry-standard wired or wireless access points, cell phone cells, or network nodes. In some examples, users can register to use the remote server 150 through the agricultural machine 10 and/or the electronic device 44, which may provide access to the agricultural machine 10 and/or the electronic device 44 and/or thereby allow the server 150 to communicate directly or indirectly with the agricultural machine 10 and/or the electronic device 44. In various instances, the agricultural machine 10 and/or the electronic device 44 may also communicate directly, or indirectly, with the agricultural machine 10 and/or the electronic device 44 or one of the cloud-based applications 272 in addition to communicating with or through the server 150. According to some examples, the agricultural machine 10 and/or the electronic device 44 can be preconfigured at the time of manufacture with a communication address (e.g. a URL, an IP address, etc.) for communicating with the server 150 and may or may not have the ability to upgrade or change or add to the preconfigured communication address.

Referring still to FIG. 5, when a new cloud-based application 158 is developed and introduced, the server 150 can be upgraded to be able to receive communications for the new cloud-based application 158 and to translate communications between the new protocol and the protocol used by the agricultural machine 10 and/or the electronic device 44. The flexibility, scalability, and upgradeability of current server technology render the task of adding new cloud-based application protocols to the server 150 relatively quick and easy.

In several embodiments, an application interface 160 may be operably coupled with the cloud 152 and/or the application 158. The application interface 160 may be configured to receive data related to the agricultural machine 10 and/or the electronic device 44. In various embodiments, one or more inputs related to the operation data 246 (FIG. 4), the object data (FIG. 4), and/or the map data (FIG. 4) may be provided to the application interface 160. For example, a farmer, a machine user, a company, or other persons may access the application interface 160 to enter the inputs related to the field data 246. Additionally or alternatively, the inputs related to the operation data 246 (FIG. 4), the object data (FIG. 4), and/or the map data (FIG. 4) may be received from a remote server 150. For example, the inputs related to the operation data 246 (FIG. 4), the object data (FIG. 4), and/or the map data (FIG. 4) may be received in the form of software that can include one or more objects, agents, lines of code, threads, subroutines, databases, application programming interfaces (APIs), or other suitable data structures, source code (human-readable), object code (machine-readable). In response, the system 100 may update any input/output based on the received inputs. The application interface 160 can be implemented in hardware, software, or a suitable combination of hardware and software, and which can be one or more software systems operating on a general-purpose processor platform, a digital signal processor platform, or other suitable processors.

In some examples, at various predefined periods and/or times, the agricultural machine 10 and/or the electronic device 44 may communicate with the server 150 through the network/cloud 152 to obtain the stored instructions and/or data, if any exist. Upon receiving the stored instructions and/or data, the agricultural machine 10 and/or the electronic device 44 may implement the instructions and/or data. In some instances, the agricultural machine 10 and/or the electronic device 44 can send event-related data to the server 150 for storage in the data store 156. This collection of event-related data can be accessed by any number of users, the agricultural machine 10, and/or the electronic device 44 to assist with application processes.

In various embodiments, the data used by the agricultural machine 10, the electronic device 44, the remote server 150, the data store 156, the application 158, the application interface 160, and/or any other component for any purpose may be based on data provided by the one or more operation sensors 42, the positioning system 118 operably coupled with the agricultural machine 10, and/or third-party data that may be converted into comparable data that may be used independently or in conjunction with data collected from the one or more operation sensors 42.

In various examples, the server 150 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the server 150 through the network/cloud 152 and may be used to generate a predictive evaluation of the work vehicle 12, the implement, the field 16, the crop material 22 within the field 16, and/or any other condition that can affect the operation. In some instances, the machine learning engine may allow for changes to a control output to be performed without human intervention.

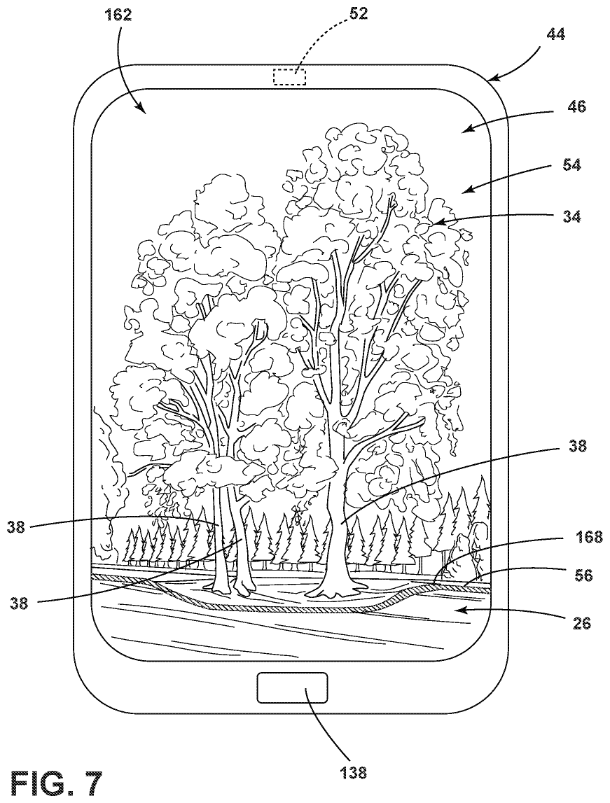

Referring to FIGS. 6-13, various images 54 during a first operation (FIGS. 6-8), such as an application operation, and a second operation (FIGS. 7-13), such as a harvesting operation, are illustrated. In general, while each operation is performed within the field 16, the electronic device 44 may provide images 54 with augmented graphics 56 that is determined based on the data from the operation sensors 42 and/or the data received from the imager 52 along with a geographic position, an imager direction, and a tilt of the electronic device 44 (and/or the imager 52). Based on the geographic position, the imager direction, and the tilt of the electronic device 44, various graphics 56 may be overlaid onto the display 46. In some instances, the system 100 may automatically detect various conditions of the operation and/or the object 34 within the field 16 to determine the graphics 56 to be displayed on the electronic device 44. For example, the graphics 56 may be post-operation graphics 56 when the imager 52 is directed towards a processed segment 24 of the field 16 that has been processed and pre-operation graphics 56 when the imager 52 is generally directed towards an unprocessed segment 26 of the field 16 that is to be processed. In the illustrated examples, the images 54 are provided in a first-person perspective. In various examples, the images 54 may be provided in any other perspective, such as a bird's eye view, with any augmented graphics 56 without departing from the scope of the present disclosure. In addition, while the electronic device 44 is illustrated in FIGS. 6-13 as a cellular phone, the electronic device 44 may be any other device that includes a display 46 without departing from the teachings provided herein. For example, the electronic device 44 may additionally or alternatively may be configured as a tablet, a heads-up display (HUD) that is integrated into one or more windows 48 of the cab 30, a wearable device 50, and/or any other device.

Referring further to FIGS. 6-13, in various examples, the objects 34 and features of the objects 34 imaged by the electronic device 44 may be provided to the computing system 102 for processing. For example, the images 54 provided to the computing system 102 may be processed to determine one or more objects 34 within the field 16. In turn, the detected objects 34 may be compared to previous images 54 to determine any changes within the field 16. If any changes are detected, the graphics 56 and/or one or more maps or suggested paths for the agricultural machine 10 may be updated.

Referring further to FIGS. 6-8, a schematic diagram of the agricultural machine 10 within the field 16 during a first operation, a first image 54 displayed on the electronic device 44 while the imager 52 is directed in a first position 162, and a second image 54 displayed on the electronic device 44 while the imager 52 is directed in a second position 164 are respectively illustrated in accordance with various aspects of the present disclosure. In general, the agricultural machine 10 may be in the form of an applicator that is configured to apply an agricultural product, such as pesticides (e.g., herbicides, insecticides, rodenticides, etc.) and/or nutrients, to the field 16.

With further reference to FIG. 6, during the first operation, the imager 52 may be oriented in a first position 162, which may be at least partially outward from a right side of the cab 30. Additionally or alternatively, during the first operation, the imager 52 may be oriented in a second position 164, which may be at least partially forward of the cab 30. While in the first position 162 and the second position 164, a field of view 166 of the electronic device 44 may define the bounds of the image 54 displayed on the electronic device 44.

Referring to FIG. 7, an image 54 of an unprocessed segment 26 of the field 16 laterally outward of the cab 30 may be displayed in accordance with various examples of the present disclosure. In addition, the captured image 54 may be visually augmented with graphics 56 in the form of a projected path 168 of the vehicle 12 to traverse about a tree 38, or another object 34, that may be positioned within the field 16. In addition to detecting the object 34, the system 100 may determine features (e.g., shape, size, location, etc.) of the object 34 and compare the features (e.g., shape, size, location, etc.) to previous data to determine any changes to the object 34. If any changes have occurred, the projected path 168 and/or any other graphics 56 may be updated.

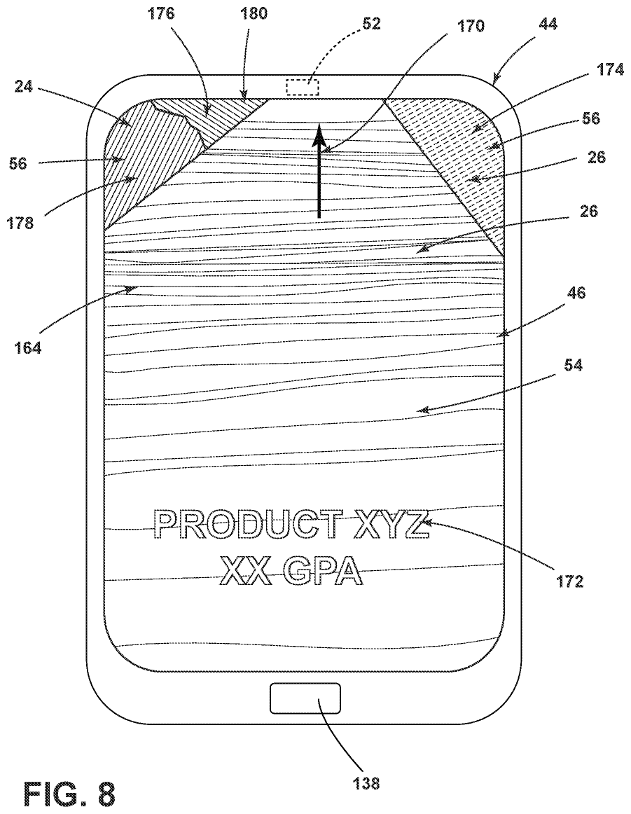

Referring to FIG. 8, an image 54 of a processed segment 24 and an unprocessed segment 26 of the field 16 forwardly and/or laterally offset of the cab 30 may be displayed in accordance with various examples of the present disclosure. As illustrated, the captured image 54 may be visually augmented with graphics 56 in the form of a path of travel 170 for the agricultural machine 10 within the current swath. Additionally or alternatively, the captured image 54 may be visually augmented with graphics 56 in the form of status notifications 172 that identify various graphics 56 about the current operation. For instance, the status notifications 172 may include a type of agricultural product being applied to the field 16 and/or a volume of agricultural product being applied to the field 16. In some examples, the status notifications 172 may also be in the form of potential issues with the operation, such as a malfunction of a component of the implement 14.

Additionally or alternatively, the captured image 54 may be visually augmented with graphics 56 in the form of a prescription map 174 that identifies areas within the field 16 that are to have the agricultural product applied thereto and/or illustrated areas of varying volumes of agricultural product. Additionally or alternatively, the captured image 54 may be visually augmented with graphics 56 in the form of an application map 176 that identifies regions 178 within the field 16 that the computing system 102 deems to have received sufficient application of agricultural product thereto and/or regions 180 within the field 16 that the computing system 102 deems may have not received sufficient application of agricultural product thereto. In some instances, additional graphics 56 may be augmented onto the display 46 to reapply the agricultural product to the regions 180, which may be in the form of supplemental suggested travel paths to the regions of concern.

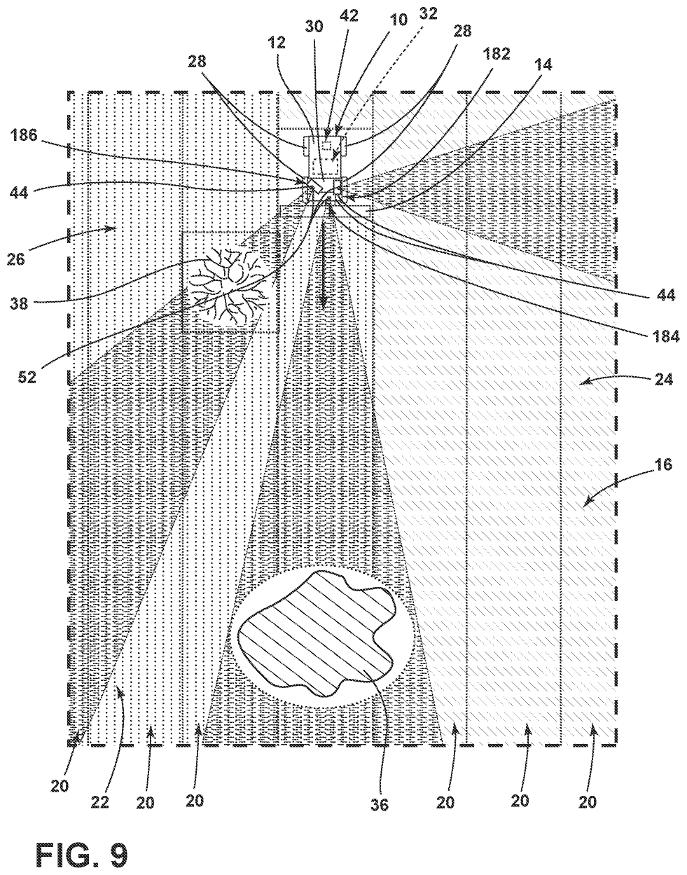

Referring further to FIGS. 9-13, a schematic diagram of the agricultural machine 10 within the field 16 during a second operation and various images 54 of the field 16 based on the orientation of the imager 52 of the electronic device 44 are illustrated in accordance with various aspects of the present disclosure. In general, the agricultural machine 10 may be in the form of a harvester that is configured to sever crop material 22 from the field 16 and direct the crop material 22 into the harvester. As illustrated in FIG. 9, a first portion of the field 16 has been harvested while a second portion of the field 16 is to be harvested.

With further reference to FIG. 9, the electronic device 44 may be oriented such that the imager 52 coupled therewith is placed in a first position 182, which may be at least partially outward from a left side of the cab 30. Additionally or alternatively, the electronic device 44 may be oriented such that the imager 52 coupled therewith is placed in a second position 184, which may be at least partially forwardly of the cab 30. Additionally or alternatively, the electronic device 44 may be oriented such that the imager 52 coupled therewith is placed in a third position 186, which may be at least partially outward from a right side of the cab 30. When in the first position 182, the second position 184, or the third position 186, a field of view 166 of the electronic device 44 may define the bounds of the image 54 displayed on the electronic device 44.

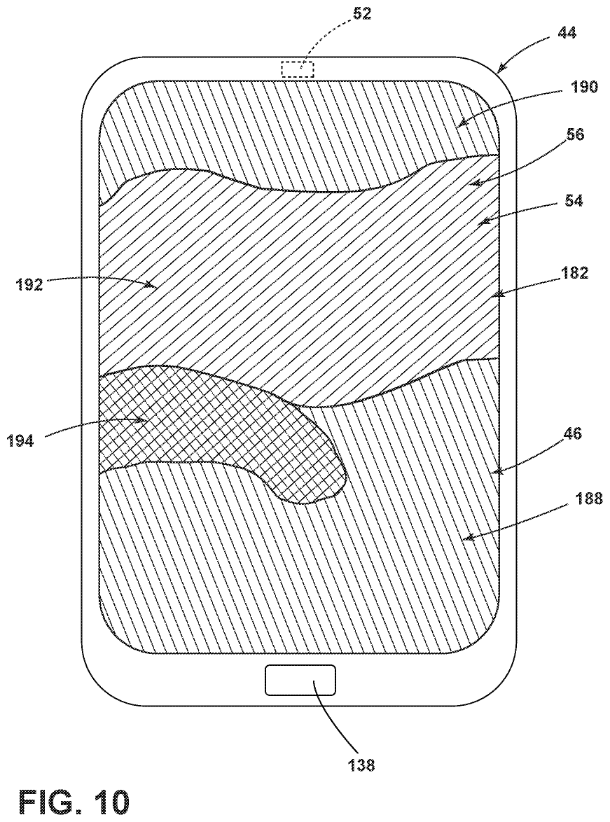

Referring to FIG. 10, an image 54 of a processed segment 24 of the field 16 laterally outward of the cab 30 may be visually augmented with graphics 56 in the form of a yield map 188. The yield map 188 is a visual representation of yield values for a number of areas of the agricultural field 16. Herein, a yield value is a quantification of yield for an area of the field 16, such as, for example, bushels harvested per acre, or dollars per acre. The yield model generates a yield map 188 from a data structure that includes a number of data cells where each data cell represents an area of the field 16. The yield model populates each data cell with a yield value using machine learning algorithms that utilize the indicators obtained from the measurement and observation systems. As illustrated, the yield map 188 may provide one or more sections 190, 192, 194 that have varied yields relative to defined ranges. For example, a first section 190 may illustrate a portion of the field 16 that produced a yield that is above a first threshold. A second section 192 may illustrate a portion of the field 16 that produced a yield that is below a first threshold and above a second threshold. A third section 194 may illustrate a portion of the field 16 that produced a yield that is below the second threshold. In some instances, the yield data may also drive additional prescriptive services such as variable-rate seeding, fertilization, management, irrigation, etc. In such cases, any graphics 56 related to the prescriptive services may also be augmented on the display 46.

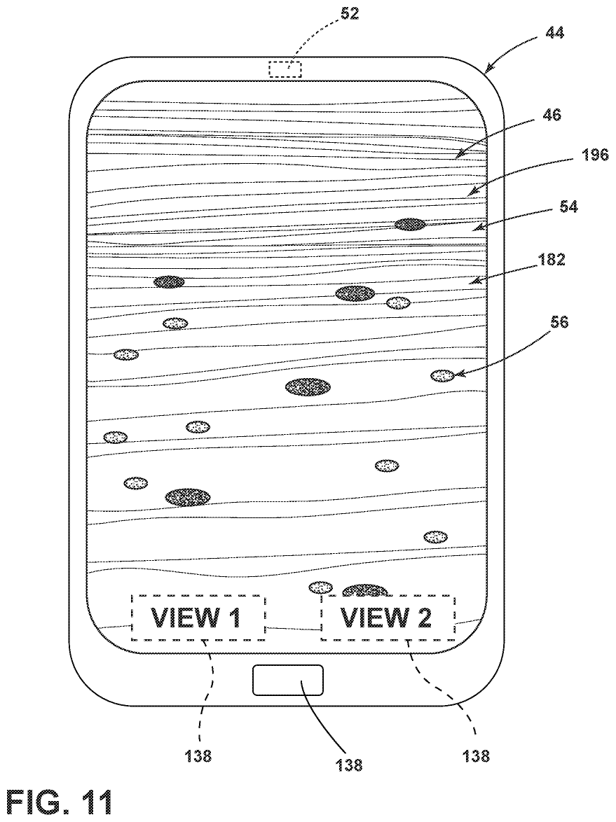

Referring to FIG. 11, an image 54 of the processed segment 24 of the field 16 laterally outward of the cab 30 may be visually augmented with graphics 56 in the form of a soil clod map 196. Soil clods refer to portions of the soil that are denser than the surrounding soil, thereby forming a separate clod. For various reasons, it may be desired to maintain a given amount of soil roughness within the field 16 before or following an agricultural operation. For example, when planting seeds it is generally not desired to have soil clods that are larger than a certain size. As such, the ability to view the amount of soil roughness within the field 16 can be pertinent to maintaining a healthy, productive field 16.

In various examples, the graphics 56 to be augmented on the image 54 may be chosen by a user through one or more input devices 138. As such, while the imager 52 is in the first position 182, the user may choose to view the yield map 188, the clod map 196, and/or any other graphics 56. In addition, the graphics 56 that is to be displayed may be based on the computing system 102 detecting various features of the field 16. For instance, the yield map 188 may be an option to be chosen for a current operation based on a status of the field 16 within the field of view 166 of the imager 52. For example, the yield map 188 may be an option for the first segment of the field 16 but not on the second segment of the field 16 as the second segment has not been harvested.

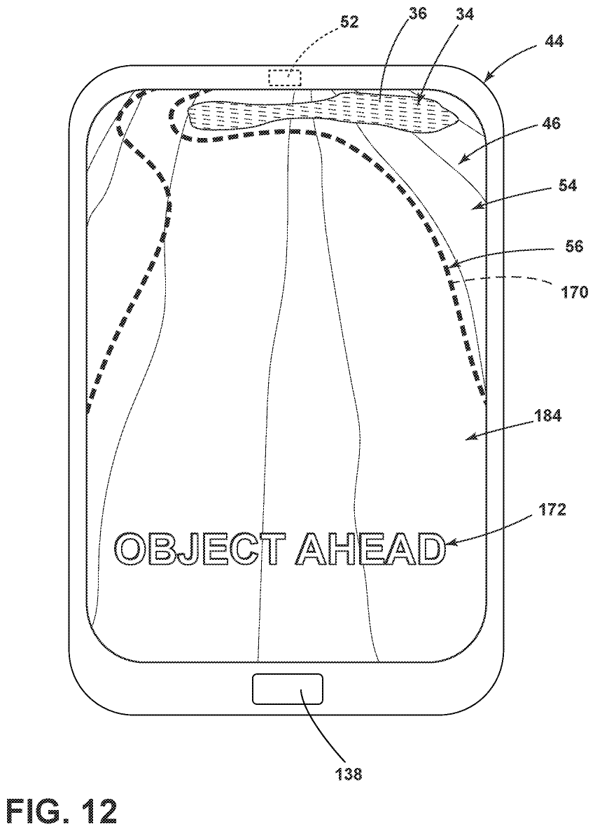

Referring to FIG. 12, an image 54 of an unprocessed segment 26 of the field 16 forwardly and/or laterally offset of the cab 30 may be visually augmented with graphics 56 in the form of a path of travel 170 for the agricultural machine 10 within the current swath. Additionally or alternatively, the captured image 54 may be visually augmented with graphics 56 related to an upcoming object 34 and/or a variation in path due to the object 34. In addition to traversing around the object 34, the imager 52 may collect data related to the imaged object 34 for processing and/or analysis, which may include comparing the features (e.g., shape, size, location, etc.) of the object 34 to previously-stored map data and/or image data to determine if any changes have occurred. In instances in which changes have occurred, one or more future operations may be updated based on the changed features of the object 34.

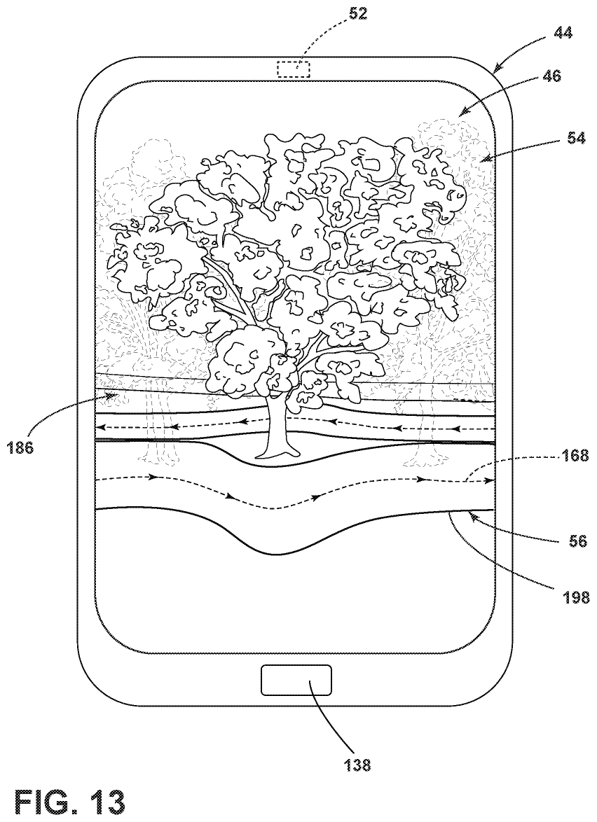

Referring to FIG. 13, an image 54 of an unprocessed segment 26 of the field 16 at least partially to the right of the cab 30 may be visually augmented with graphics 56 in the form of future projected paths 170 of travel for the agricultural machine 10 within projected swaths 198. As provided herein, the imager 52 may collect data related to one or more imaged objects 34 for processing and/or analysis, which may include comparing the features (e.g., shape, size, location, etc.) of the object 34 to the previously stored map data and/or image data to determine if any changes have occurred and/or any additional objects 34 are detected. For instance, as illustrated in FIG. 7, during the first operation, a set of three trees 38 may be present within a defined location of the field 16. However, during the second operation, a single tree 38 may be within the defined location. As such, the system 100 may update the map data and/or the object data based on the removal of the trees 38. In addition, the computing system 102 may monitor the map data and/or the object data the remaining features of the tree 38 to determine whether any other changes have occurred that may affect future operations. For instance, as the tree 38 grows, an area beneath the tree 38 that should be left unseeded may also grow in size. Additionally or alternatively, various amounts of an agricultural product may be applied to the crop proximate to the tree 38 based on the crops receiving a diminished amount of light due to the canopy of the tree 38.

In various examples, the graphics 56 can be related to the change in the feature of the object 34 and/or a presence of a new object 34 within the field 16. Additionally or alternatively, the field 16 map or the map data can be updated based on the change in the feature of the object 34 and/or based on the presence of a new object 34.

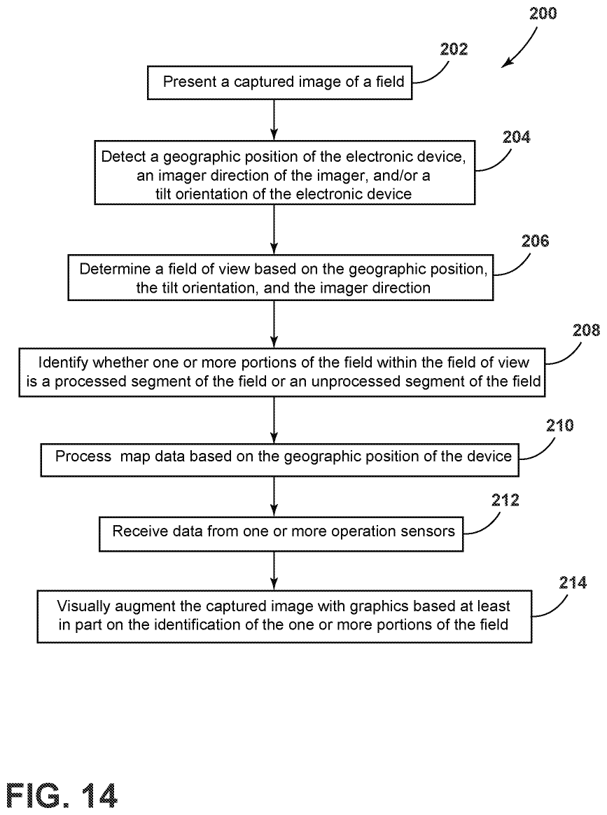

Referring now to FIG. 14, a flow diagram of a method 200 for an agricultural operation is illustrated in accordance with aspects of the present subject matter. In general, the method 200 will be described herein with reference to the agricultural machine 10 shown in FIG. 1-3 and the various system components shown in FIGS. 4 and 5. However, it will be appreciated that the disclosed method 200 may be implemented with agricultural machines having any other suitable machine configurations and/or within systems having any other suitable system configuration. In addition, although FIG. 14 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (202), the method 200 can include presenting a captured image of a field on a display of an electronic device. As provided herein, the image may be captured by an imager operably coupled with the electronic device. Although described here in reference to an image, the method 200 may additionally or alternatively include capturing and displaying a series of still images and/or a video stream.

In various examples, the electronic device may be in the form of a tablet, cellular phone, or the like. Additionally or alternatively, the electronic device may be in the form of a wearable device, such as glasses. Additionally or alternatively, the electronic device may be a heads-up display (HUD) that is integrated into one or more windows of the cab, and/or any other device that may be integrated within a cab of the work vehicle. As such, in some instances, presenting the captured image of the field on the display of the electronic device may further include projecting the graphics onto a window of a cab through a heads-up display.

At (204), the method 200 includes detecting a geographic position of the electronic device, an imager direction of the imager, and/or a tilt orientation of the electronic device. At (206), the method 200 includes determining a field of view based on the geographic position, the tilt orientation, and the imager direction.

At (208), the method 200 includes identifying whether one or more portions of the field within the field of view is a processed segment of the field or an unprocessed segment of the field. As provided herein, the agricultural machine may perform various operations on the field. As such, during an operation, a portion of the field will be processed once an operation has been completed thereon while a portion of the field will be unprocessed until the operation is performed thereon.

At (210), the method 200 includes processing map data based on the geographic position of the electronic device. In some instances, at (212), the method 200 can include receiving data from one or more operation sensors. The operation sensor may be configured to capture data related to at least one of a work vehicle, an implement, the field, or a crop within the field.

At (214), the method 200 can include visually augmenting the captured image with graphics based at least in part on the identification of the one or more portions of the field. In various examples, the graphics is based at least in part on the map data and/or the data provided by one or more operation sensors.

In some examples, visually augmenting the captured image with graphics based at least in part on the identification of the one or more portions of the field further includes overlaying graphics in the form of a first illustration when at least a portion of the image includes the processed segment of the field. In such instances, the method 200 may further include generating a yield map and/or a soil clod map as the first illustration.

In some examples, visually augmenting the captured image with graphics based at least in part on the identification of the one or more portions of the field further comprises overlaying graphics in the form of a second illustration when at least a portion of the image includes the unprocessed segment of the field. In such instances, the method 200 may further include generating a projected path and/or one or more future swath paths as the second illustration.

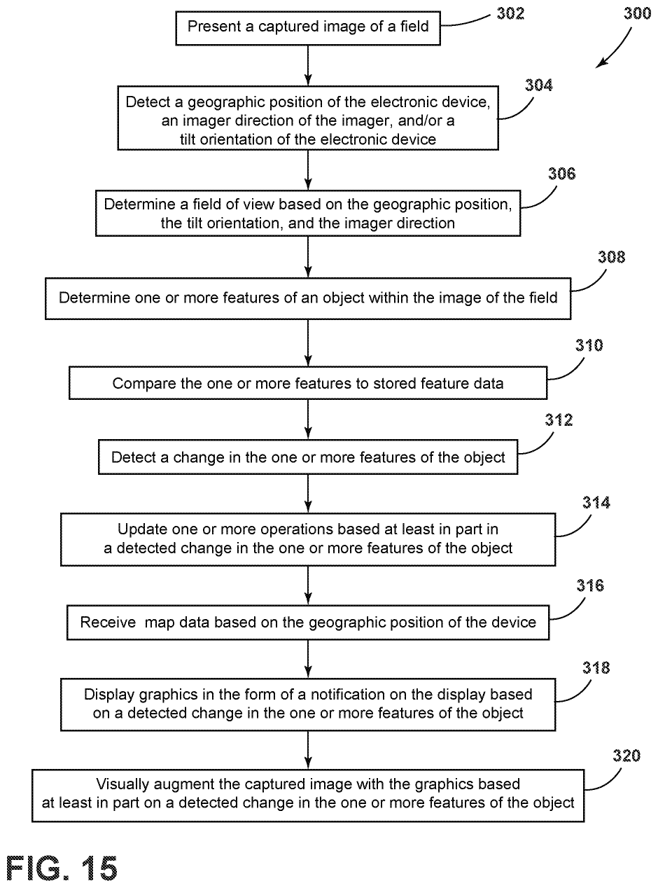

Referring now to FIG. 15, a flow diagram of a method 300 for an agricultural operation is illustrated in accordance with aspects of the present subject matter. In general, the method 300 will be described herein with reference to the agricultural machine 10 shown in FIG. 1-3 and the various system components shown in FIGS. 4 and 5. However, it will be appreciated that the disclosed method 300 may be implemented with agricultural machines having any other suitable machine configurations and/or within systems having any other suitable system configuration. In addition, although FIG. 12 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As illustrated, at (302), the method 300 can include presenting a captured image of a field on a display of an electronic device. As provided herein, the image may be captured by an imager operably coupled with the electronic device. Although described here in reference to an image, the method 300 may additionally or alternatively include capturing and displaying a series of still images and/or a video stream.

In various examples, the electronic device may be in the form of a tablet, cellular phone, or the like. Additionally or alternatively, the electronic device may be in the form of a wearable device, such as glasses. Additionally or alternatively, the electronic device may be a heads-up display (HUD) that is integrated into one or more windows of the cab, and/or any other device that may be integrated within a cab of the work vehicle. As such, in some instances, presenting the captured image of the field on the display of the electronic device may further include projecting the graphics onto a window of a cab through a heads-up display.

At (304), the method 300 includes detecting a geographic position of the electronic device, an imager direction of the imager, and/or a tilt orientation of the electronic device. At (306), the method 300 includes determining a field of view based on the geographic position, the tilt orientation, and the imager direction.

At (308), the method 300 can include determining one or more features of an object within the image of the field. In various examples, the one or more features of the object can include at least one of a shape, a size, or a location of the object. In some examples, the shape or the size of the object can be calculated based on the captured image through any method, such as one or more image processing algorithms, to determine the size and/or the shape of the object.

At (310), the method 300 can include comparing the one or more features to stored feature data. At (312), the method 300 can include detecting a change in the one or more features of the object between the currently captured image and a previously stored image. In some instances, the previously stored image may be from a previous operation within the field and/or inputted through any other method. In addition, in various instances, the features of the object may be stored such that the features can be compared, even when the currently captured image and the previously stored image are taken from varied angles and/or perspectives.

At (314), the method 300 can include updating one or more operations based at least in part on a detected change in the one or more features of the object. For instance, when the object is identified as a tree, an area beneath the tree that may be left unseeded may also grow in size as the tree grows. Additionally or alternatively, various amounts of an agricultural product may be applied to the crop proximate to the tree based on the crops receiving a diminished amount of light due to the canopy of the tree.

At (316), the method 300 can include receiving map data based on the geographic position of the electronic device. In some instances, receiving map data based on the geographic position of the electronic device can further include receiving the map data from a remote storage device through communication with a network/cloud. In addition, the method 300 may include geolocating the object within the field based on the map data and/or storing the one or more features of the object based on the position of the object within the field.

At (318), the method 300 can include displaying graphics in the form of a notification on the display based on a detected change in the one or more features of the object. Additionally or alternatively, at (320), the method 300 can include visually augmenting the captured image with the graphics based at least in part on a detected change in the one or more features of the object.

In various examples, the methods 200, 300 may implement machine learning methods and algorithms that utilize one or several vehicle learning techniques including, for example, decision tree learning, including, for example, random forest or conditional inference trees methods, neural networks, support vector vehicles, clustering, and Bayesian networks. These algorithms can include computer-executable code that can be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method for operating an agricultural system, the method comprising:
presenting, on a display of an electronic device, an image of a field, the image being captured by an imager operably coupled with the electronic device;
detecting a geographic position of the electronic device and an imager direction of the imager;
determining a tilt orientation of the electronic device;
determining a field of view based on the geographic position, the tilt orientation, and the imager direction;
determining one or more features of an object within the image of the field;
comparing the one or more features to stored feature data; and
detecting a change in the one or more features of the object.

2. The method of claim 1, further comprising:
receiving map data based on the geographic position of the electronic device; and
geolocating the object within the field based on the map data.

3. The method of claim 2, wherein receiving map data based on the geographic position of the electronic device further comprises receiving the map data from a remote storage device through communication with a network/cloud.

4. The method of claim 2, further comprising:
storing the one or more features of the object based on the position of the object within the field.

5. The method of claim 4, further comprising:
updating one or more operations based at least in part on a detected change in the one or more features of the object.

6. The method of claim 1, wherein the one or more features of the object include at least one of a shape, size, or location of the object.

7. The method of claim 6, wherein the shape or the size of the object is calculated based on the captured image.

8. The method of claim 1, further comprising:
displaying graphics in the form of a notification on the display based on a detected change in the one or more features of the object.

9. The method of claim 8, further comprising:
visually augmenting the captured image with the graphics based at least in part on a detected change in the one or more features of the object.

10. The method of claim 8, wherein the graphics are displayed on a window of a cab through a heads-up display.

11. A system for an agricultural operation, the system comprising:
an imager configured to capture one or more images;
a display configured to present the one or more images;
a positioning system configured to determine location coordinates to identify a location of the imager;
an inertial measurement unit configured to determine an imager direction of the imager and a tilt orientation of the imager, the tilt orientation being relative to one or more of a horizontal axis and a vertical axis; and
a computing system communicatively coupled to the imager, the display, the positioning system, and the inertial measurement unit, the computing system including a processor and associated memory, the memory storing instructions that, when implemented by the processor, configure the computing system to:
detect an object within the one or more images during a first operation;
determine at least one feature of the object during the first operation; and
store a location of the object and the at least one feature of the object.

12. The system of claim 11, wherein the computing system is further configured to:
detect the object within the one or more images during a second operation;
determine the at least one feature of the object during the second operation; and
detect one or more changes to the at least one feature based on the one or more images during the first operation and the one or more images during the second operation.

13. The system of claim 12, wherein the computing system is further configured to:
update a field map based on the one or more changes to the at least one feature.

14. The system of claim 13, wherein the inertial measurement unit includes an accelerometer for determining the tilt orientation of the imager.

15. The system of claim 11, wherein the inertial measurement unit includes a digital compass configured to determine the imager direction of the imager.

16. A system for an agricultural operation, the system comprising:
an imager configured to record an image, the image including objects and the imager having a field of view;
a positioning system configured to determine location coordinates to identify a location of the imager;
an inertial measurement unit configured to determine an imager direction of the imager and a tilt orientation of the imager, the tilt orientation being relative to one or more of a horizontal axis and a vertical axis;
a display; and
a computing system communicatively coupled to the imager, the display, the positioning system, and the inertial measurement unit, the computing system including a processor and associated memory, the memory storing instructions that, when implemented by the processor, configure the computing system to:
determine the field of view based on the location, the tilt orientation, and the imager direction;
detect an object within the image;
determine one or more features of the object; and
store the one or features and a position of the object relative to a field map.

17. The system of claim 16, wherein the computing system is further configured to:
overlay, on the one or more images presented on the display, graphics related to the object based at least in part on the positioning system and the inertial measurement unit.

18. The system of claim 17, wherein the one or more features of the object include at least one of a shape, size, or location of the object.

19. The system of claim 18, wherein the graphics is related to a change in the position or the size of the object, and wherein the field map is updated based on the position or the size of the object.

20. The system of claim 17, wherein the graphics is related to a presence of a new object within the field, and wherein the field map is updated based on the presence of a new object.
